(19) United States
(12) Patent Application Publication
(10) Pub. No.: US 2025/0372114 A1
(43) Pub. Date: Dec. 4, 2025

(54) JOINT UNSUPERVISED AND SUPERVISED TRAINING FOR AUTOMATIC SPEECH RECOGNITION

(71) Applicants: International Business Machines Corporation, Armonk, NY (US); Rensselaer Polytechnic Institute, Troy, NY (US)

(72) Inventors: Xiaodong Cui, Chappaqua, NY (US); Songtao Lu, White Plains, NY (US); Brian E. D. Kingsbury, Cortlandt Manor, NY (US); Tianyi Chen, Rensselaer, NY (US); A F M Saif, Troy, NY (US)

(21) Appl. No.: 18/731,228

(22) Filed: May 31, 2024

(51) Int. Cl. G10L 25/30; G10L 15/06

(52) U.S. Cl. CPC G10L 25/30; G10L 15/063

(57) ABSTRACT

A backbone model parameter and a classification head parameter are randomly initialized. A gradient descent is applied to a lower-level unsupervised loss with respect to the initialized backbone model parameter and the initialized backbone model parameter is updated. A gradient descent is applied to a higher-level supervised loss and the initialized classification head parameter is updated. Deployment of the updated backbone model parameter and the updated classification head parameter are facilitated.

### STATEMENT REGARDING PRIOR DISCLOSURES BY THE INVENTOR OR A JOINT INVENTOR

The following disclosure(s) is/are submitted under 35 U.S.C. 102(b)(1)(A):

A F M Saif, Xiaodong Cui, Han Shen, Songtao Lu, Brian Kingsbury, and Tianyi Chen, Joint Unsupervised and Supervised Training for Automatic Speech Recognition via Bilevel Optimization, arXiv preprint arXiv: 2401.06980. 2024 Jan. 13. (5 pages).

### BACKGROUND

The present invention relates generally to the electrical, electronic and computer arts and, more particularly, to machine learning and automatic speech recognition.

The high performance of conventional automatic speech recognition (ASR) models relies on a large amount of labeled data that is expensive to obtain. To overcome this issue, a two-stage approach of pre-training followed by fine-tuning (PT+FT) has been actively studied and yielded good performance. In the PT+FT strategy, a deep neural network model is first trained in an unsupervised fashion on a large amount of unlabeled data and then fine-tuned with labeled data in downstream applications. In this strategy, however, ASR models are pre-trained independently without considering any feedback from the downstream fine-tuning tasks. Consequently, the fine-tuning step has limited control over the upstream pre-training. Moreover, there is no guarantee of shared local optima for both training loss landscapes. Hence, when the pre-trained and fine-tuned domains are not closely related, there is a mismatch in transferring knowledge. In some cases, it may even adversely impact the model's performance, a phenomenon referred to as negative transfer. Furthermore, the PT+FT approach necessitates two separate training loops, where the first loop is for pre-training and the second loop is for fine-tuning. This disconnected training increases the complexity and processing time of training.

### BRIEF SUMMARY

Principles of the invention provide systems and techniques for joint unsupervised and supervised training for automatic speech recognition. In one aspect, an exemplary method includes the operations of randomly initializing a backbone model parameter and a classification head parameter; applying a gradient descent to a lower-level unsupervised loss with respect to the initialized backbone model parameter and updating the initialized backbone model parameter; applying a gradient descent to a higher-level supervised loss and updating the initialized classification head parameter; and facilitating deployment of the updated backbone model parameter and the updated classification head parameter.

In one aspect, a computer program product comprises one or more tangible computer-readable storage media and program instructions stored on at least one of the one or more tangible computer-readable storage media, the program instructions executable by a processor, the program instructions comprising randomly initializing a backbone model parameter and a classification head parameter; applying a gradient descent to a lower-level unsupervised loss with respect to the initialized backbone model parameter and updating the initialized backbone model parameter; applying a gradient descent to a higher-level supervised loss and updating the initialized classification head parameter; and facilitating deployment of the updated backbone model parameter and the updated classification head parameter.

In one aspect, an apparatus comprises a memory and at least one processor, coupled to the memory, and operative to perform operations comprising randomly initializing a backbone model parameter and a classification head parameter; applying a gradient descent to a lower-level unsupervised loss with respect to the initialized backbone model parameter and updating the initialized backbone model parameter; applying a gradient descent to a higher-level supervised loss and updating the initialized classification head parameter; and facilitating deployment of the updated backbone model parameter and the updated classification head parameter.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
joint unsupervised and supervised training for automatic speech recognition;
leveraging of penalty-based bilevel optimization to provide rigorous convergence guarantees;
reduction in the adverse impact on a model's performance caused by negative transfer;
reduction in the training time and computational resources for pre-training and fine-tuning a neural network model, especially for large datasets;
joint unsupervised and supervised training of acoustic models in ASR tasks that is formulated as a bilevel optimization problem to overcome data scarcity and negative transfer issues;
a better feature representation for machine learning with improved ASR performance;
a single training loop for combined unsupervised and supervised training which effectively reduces the number of epochs needed for training;
elimination of the management and complexity of dual loop pre-training and fine-tuning of neural network models; and
elimination of limited control over learned features and potential conflicts caused by conventional pre-training and fine-tuning approaches.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A illustrates a comparison between the JUST training method (lower) and a conventional PT+FT method (upper), in accordance with example embodiments;

FIG. 1B illustrates the relationship between the parameters of the upper-level problem and the lower-level problem, in accordance with an example embodiment;

FIG. 1C illustrates a second example JUST training algorithm, in accordance with an example embodiment;

FIG. 2A is a table illustrating the word error rates (WERs) under various hyperparameter settings of JUST using a conventional transformer and convolutional neural network-long short-term memory (CNN-LSTM) acoustic models on a first conventional dataset, in accordance with an example embodiment;

FIG. 2B is a table illustrating the WERs for a supervised training baseline, PT+FT and JUST using the convolution-augmented transformer and CNN-LSTM acoustic models, respectively, on the first conventional dataset, in accordance with an example embodiment;

FIG. 2C is a table illustrating the WERs for a supervised training baseline, PT+FT and JUST using the convolution-augmented transformer and CNN-LSTM acoustic models, respectively, on the first conventional dataset, in accordance with an example embodiment;

FIG. 2D is a table illustrating the WERs for the supervised training, PT+FT and JUST using the convolution-augmented transformer and CNN-LSTM acoustic models, respectively, on the first conventional dataset, in accordance with an example embodiment;

FIG. 2E is a table illustrating the WERs on the second conventional dataset using a convolution-augmented transformer acoustic model, in accordance with example embodiments;

FIG. 2F is a table illustrating the effect of the rate of change of penalty constant in bilevel optimization under various amounts of supervised and unsupervised data, in accordance with example embodiments;

FIG. 3 illustrates training losses of JUST vs. PT+FT on 100 hours of speech using the first conventional dataset, in accordance with example embodiments; and

FIG. 4 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, bilevel optimization-based training approaches, systems and methods for training acoustic models for automatic speech recognition (ASR) tasks, referred to as joint unsupervised and supervised training (JUST) herein, are disclosed. JUST employs a lower-level optimization with an unsupervised loss and an upper-level optimization with a supervised loss, leveraging penalty-based bilevel optimization to provide rigorous convergence guarantees. Extensive experiments have been conducted on two conventional datasets. JUST is shown to achieve superior performance over the commonly used pre-training followed by fine-tuning strategy.

### INTRODUCTION

Automatic Speech Recognition (ASR) is a popular research area that plays a vital role in improving both human-human and human-machine communications. It enables the smooth conversion of speech signals into written text. Deep neural networks (DNNs) have been used to improve ASR performance. However, their performance usually relies on a large amount of labeled data that is expensive to obtain. To overcome this issue, a two-stage approach of pre-training followed by fine-tuning (PT+FT) thereafter has been actively studied and yielded good performance. In this strategy, a DNN model is first trained in an unsupervised fashion on a large amount of unlabeled data. It is then fine-tuned in a supervised training fashion on a small amount of labeled data in downstream applications.

In the PT+FT approach, the ASR model is pre-trained independently without considering any feedback from downstream fine-tuning tasks. Consequently, the fine-tuning step has limited control over the upstream pre-training. Hence, when the pre-trained and fine-tuned domains are not closely related, there is a mismatch in transferring knowledge. In some cases, it may even adversely impact the model's performance, a phenomenon referred to as negative transfer. Furthermore, the PT+FT approach necessitates two separate training loops, where the first loop is for pre-training and the second loop is for fine-tuning. This disconnected training increases the complexity and time of training.

The JUST approach is a recursive training method based on bilevel optimization which has seen increasing success in a broad variety of applications such as machine learning, image processing, and communication for hyper-parameter optimization, meta-learning and few-shot learning.

In general, bilevel optimization problems are optimization problems where the feasible set is determined (in part) using the solution set of a second optimization problem. Determining the feasible set is generally called the lower-level problem and the second parametric optimization problem is called the upper-level problem.

In the context of ASR, the unsupervised training stage, which has the goal of learning generic representations of speech signals that can be fine-tuned for a particular task, is considered as the lower-level problem. Ideally, the result of this lower-level problem is a set of initial model parameters or weights of backbone layers that promote successful and efficient learning in the upper-level supervised training, which minimizes a task-specific loss given the lower-level parameters.

In the JUST approach, to overcome data scarcity and negative transfer, the joint unsupervised and supervised training of acoustic models in ASR tasks is formulated as a bilevel optimization problem. The JUST approach leverages penalty-based bilevel optimization with joint unsupervised and supervised training to solve the resultant bilevel problem in a single-loop fashion with a rigorous convergence guarantee. Extensive experiments on the conventional datasets show that JUST has superior performance over conventional PT+FT approaches in terms of both accuracy and runtime.

### Problem Formulation

### 2.1. Bilevel Optimization Preliminaries

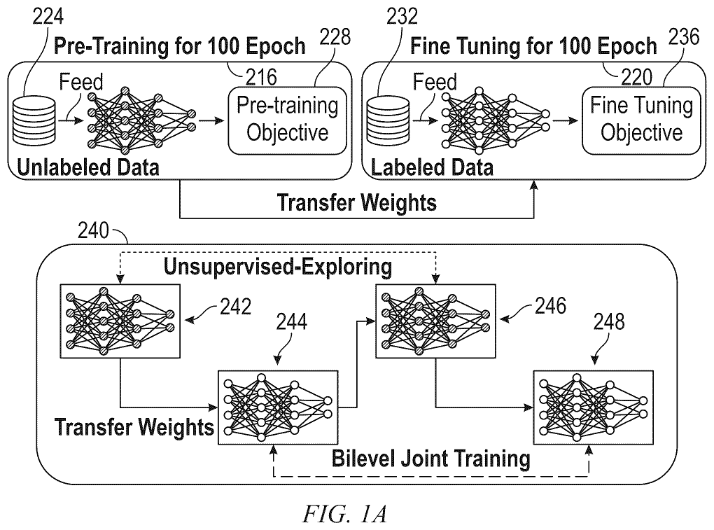

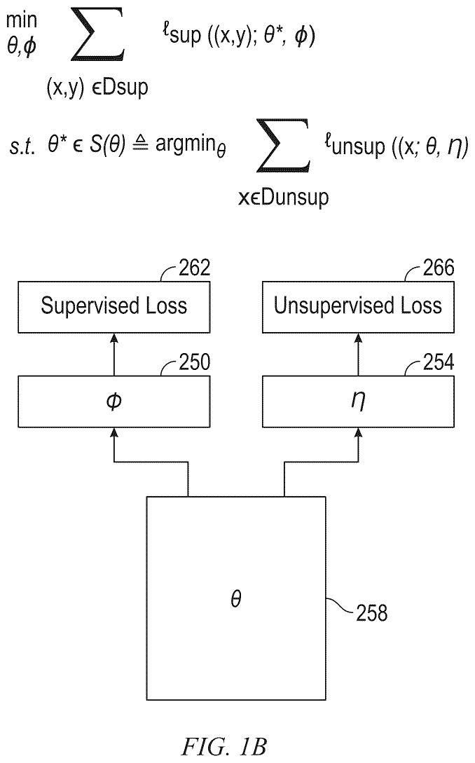

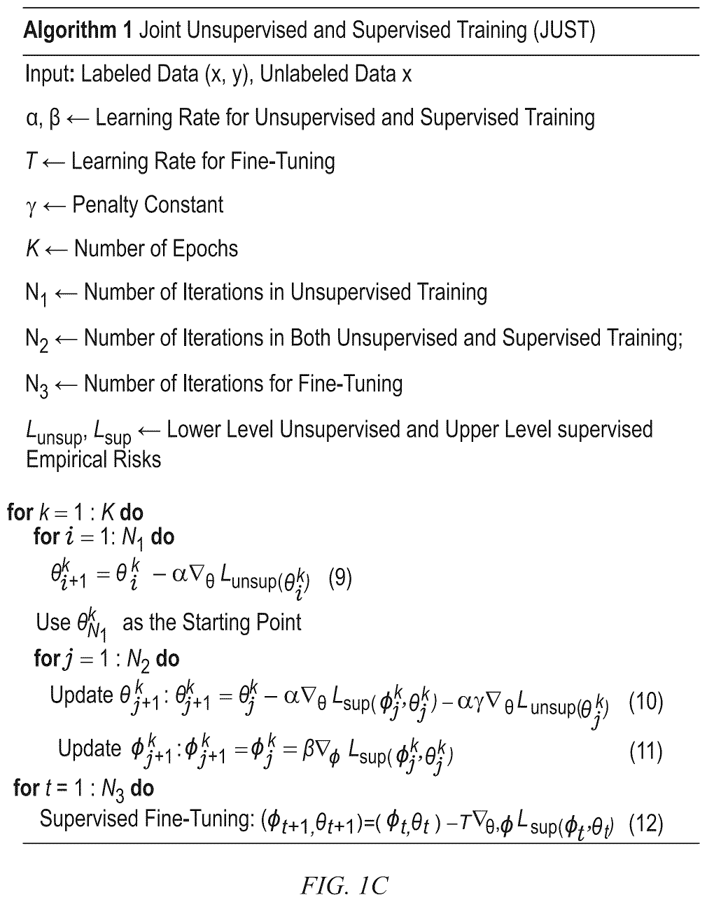

Bilevel optimization is a two-level optimization problem. The upper-level problem attempts to optimize an objective function while being constrained by factors influenced by the solutions of the lower-level problem. If the upper-level objective is defined as f: [symbol] [symbol] and the lower-level objective is defined as g: [symbol] then the bilevel optimization problem can be written as:

$${min}_{ϕ ∈ {ℝ}^{{d}_{ϕ}} , θ ∈ {ℝ}^{{d}_{ϕ}}} f ( ϕ , θ ) s . t . θ ∈ S ( ϕ ) : = arg {min}_{θ ∈ {ℝ}^{d} θ} g ( ϕ , θ ) \qquad ( 1 )$$

where S(ϕ) are non-empty and closed sets given any ϕ [symbol] ^{d}^{_{ϕ}}. Though bilevel optimization has a wide range of applications, it is difficult to solve due to its non-convex and non-differentiable nature. Recently, some implicit gradient-based and unrolled differentiation-based methods have been developed to solve bilevel optimization problems. However, those methods are costly and thus are not scalable to large models used in ASR. FIG. 1A illustrates a comparison between the JUST training method (lower) and a conventional PT+FT method (upper), in accordance with example embodiments. In the conventional PT+FT method, pre-training 216 is performed on unlabeled data 224 using an unsupervised (pre-training) objective function 228, followed by fine-tuning 220 performed on labeled data 232 using a supervised (fine-tuning) objective function 236. In one example embodiment, JUST training 240 is performed by alternating between unsupervised exploration 242, 246 and JUST training 244, 248.

### 2.2. Bilevel Optimization for Acoustic Model Training

To reformulate the acoustic model training as a bilevel optimization problem, the unsupervised and supervised objective functions are first introduced. FIG. 1B illustrates the relationship between the parameters of the upper-level problem and the lower-level problem, in accordance with an example embodiment. The lower-level problem uses the unsupervised objective function (unsupervised loss [symbol] ᵤₙₛᵤₚ) and the upper-level problem uses the supervised objective function (supervised loss [symbol] ₛᵤₚ). As described above, θ and ϕ are parameters for the model used to conduct the final ASR inference. From the optimization point of view, it can be interpreted that n is introduced to help the optimization of θ and ϕ. As illustrated in FIG. 1B, in one or more embodiments, the set of parameters 250 are used only for the supervised objective function 262 and the set of parameters 254 are used only for the unsupervised objective function 266. In addition, in one or more embodiments, a universal set of parameters 258 are used for both the supervised objective function 262 and the unsupervised objective function 266. The sets of parameters 250, 254 can be non-overlapping, partially overlapping or one set of parameters 250, 254 can be a subset of the other set of parameters 250, 254. Furthermore in this regard, in one or more embodiments, parameters 250 plus parameters 258 are total parameters (θ, ϕ) for supervised loss and parameters 254 plus parameters 258 are total parameters (θ, η) for unsupervised loss. It can be seen that in this exemplary case, parameters of supervised loss and unsupervised loss are partially overlapped. The overlapped part is 258. There can be other cases where parameters of supervised and unsupervised losses are the same or nested.

For unsupervised training, a variety of conventional unsupervised loss functions were used to learn a good representation of the input speech from unlabeled data, including the conventional unsupervised loss function defined below. Given a set of N samples X:={x₁, x₂, . . . , x_{N}} and a similarity metric f(⋅,⋅), the conventional unsupervised function, defined as:

$${L}_{NCE} ( θ ) = - 𝔼 [ log \frac{f ( {x}_{t + p} , {C}_{t} ( θ ) )}{{\sum }_{{x}^{′} ∈ {X}^{′}} f ( {x}^{′} , {C}_{t} ( θ ) )} ] \qquad ( 2 )$$

aims to maximize the probability of predicting the future sample xₜ₊ₚ given a contextual representation Cₜ(θ) generated from the speech sequence {x₁, x₂, . . . , xₜ} up to time t using a neural network parameterized by θ. In the conventional unsupervised loss, xₜ₊ₚ and Cₜ(θ) form a positive sample pair, and samples from the speech sequence at other time steps, denoted as x′∈X′, together with Cₜ(θ) form negative pairs.

For supervised training, a variety of conventional supervised loss functions were used, including the conventional supervised loss function defined below. When the input sequence is xₙ and the label sequence is yₙ, the objective of the conventional supervised loss function minimizes the negative log-likelihood of the label sequence yₙ, given by:

$${L}_{CTC} ( ϕ , θ ) = \frac{1}{N} {\sum }_{n = 1}^{N} - log P ( {y}_{n} \vert z ( {x}_{n} ; ϕ , θ ) ) \qquad ( 3 )$$

where z(xₙ; ϕ, θ) is the output of the model, ϕ is the parameters of the model's classification layer, and θ, which is referred to as the “backbone” herein, includes all the parameters except those from the classification layer.

In JUST, the two objective functions are combined into a bilevel optimization problem, where the upper-level objective is the conventional supervised loss and the lower-level objective is the conventional unsupervised loss:

$$\begin{matrix}{min}_{ϕ , θ} {L}_{CTC} ( ϕ , θ ) \\ S . t . θ ∈ S : = arg {min}_{θ} {L}_{NCE} ( θ )\end{matrix} \qquad ( 4 )$$

### Algorithm 1: The JUST Training Algorithm

In one example embodiment, the JUST training algorithm inputs labeled data (x, y) for the upper-level problem, unlabeled data (xₜ₊ₚ, x′) for the lower-level problem, learning rates α and β, and penalty constant γ. The learning rates α and β are predefined and may be determined heuristically, as would be familiar to the skilled artisan. For example, the learning rates may be selected as 10⁻³, 10⁻⁴ and the like. The penalty constant γ may also be determined heuristically and may be, for example, 1.0, 2.0 and the like. The backbone model parameter θ₁ and the classification head parameter ϕ₁ are randomly initialized. A bi-level gradient descent is then used to match a pair of local optima for both problems and both loss functions, as described above. A “do” loop is then performed to update the backbone model parameter θₖ₊₁ based on equation (6) and to update the classification head parameter ϕₖ₊₁ based on equation (7). The backbone model parameter θ_{K} and the classification head parameter ϕ_{K} are then output. In one example embodiment, K equals 30 epochs. In one example embodiment, the JUST training algorithm is defined as:

```
Randomly initialize θ₁, ϕ₁,
for k = 1, 2, 3, . . . , K do
  Update: θₖ₊₁ via (6)
  Update θₖ₊₁ via (7)
end
Output : θ_{K}, ϕ_{K}
```

In (4), the lower-level unsupervised training problem serves as the constraint for the backbone model parameters θ in the optimization of the upper-level supervised objective. The rationale for using the above bilevel optimization formulation (4) is that, due to the overparameterization of ASR models, while there might be multiple values of θ that minimize the conventional unsupervised loss, the one that also optimizes the conventional supervised loss is to be selected. By solving the above bilevel optimization problem (4), the supervised objective can be used to guide the unsupervised training, and a better feature representation with improved ASR performance can be found.

FIG. 1C illustrates a second example JUST training algorithm, in accordance with an example embodiment. In addition to the core training of the above JUST training algorithm, the JUST training algorithm of FIG. 1C includes pre-training using an unsupervised loss to perform exploration to find a “good neighborhood” (segment) of the loss curves and fine-tuning with, for example, a smaller learning rate after the core loop. In one example embodiment, the fine-tuning uses the same supervised loss function as the core loop of the above algorithm. In one example embodiment, the fine-tuning may use the same learning rate as the core loop or may use a different learning rate (but of the same order of magnitude).

In one example embodiment, the JUST training algorithm of FIG. 1C inputs labeled data (x, y) for the upper-level problem, unlabeled data (x) for the lower-level problem, learning rates α and β for the unsupervised and supervised training, respectively, and a penalty constant γ. The learning rates α and β are predefined and may be determined heuristically. For example, the learning rates may be 10⁻³ or 10⁻⁴. The penalty constant γ may also be determined heuristically and may be, for example, set to 1.0, 2.0 and the like. The number of epochs K, the number of iterations N₁ in unsupervised training, the number of iterations N₂ in supervised training, the number of iterations N₃ in fine-tuning, and the lower-level and upper-level supervised empirical risks, Lᵤₙₛᵤₚ, Lₛᵤₚ, respectively, are input. The JUST algorithm can be initialized with random weights or pre-trained weights. K is a hyper-parameter that is pre-defined and represents the number of epochs. One epoch means a whole sweep of the training data. In each epoch, the data is divided into small batches. The models are updated after each batch of the training data. (Each batch is referred to as an iteration herein.) For example, suppose the training data has 100 training samples and the model is updated every 5 training samples. Then the batch size is 5 and there are 20 iterations in each epoch. Lower-level and upper-level loss functions are determined based on the tasks. In one or more embodiments, the form of lower-level and upper-level empirical risks (also known as loss functions) are determined based on specific tasks. For example, in some cases, considering practical requirements, a connectionist temporal classification (CTC) loss is chosen over a recurrent neural network transducer (RNNT) loss for upper-level supervised training as CTC can provide better frame alignments of input speech feature sequences. In one or more embodiments, selection of loss functions is determined by the nature of the problems that are addressed. Given the teachings herein, the skilled artisan can use appropriate heuristics to select loss functions suitable for a domain of interest. Other non-limiting exemplary loss functions include the InfoNCE loss function (an unsupervised loss function), a temporal consistency (TC) loss function (a supervised loss function) and a recurrent neural network transducer (RNNT) loss function (a supervised loss function). Alternative supervised loss functions include a cross-entropy loss, a minimum word error rate loss, and the like. Other unsupervised loss functions include a mean square error loss. A variety of suitable loss functions can be used with embodiments of the invention, as would be appreciated by the skilled artisan, given the teachings herein.

A bi-level gradient descent is then used to match pair of local optima for both problems and their corresponding loss functions. A pre-training “do” loop is performed to update the backbone model parameter

$${θ}_{i + 1}^{k}$$

based on equation (9). In one example embodiment, the pre-training “do” loop is performed for 30 iterations.

Using the backbone model parameter

$${θ}_{{N}_{1}}^{k}$$

as the starting point, a core “do” loop is then performed to update the backbone model parameter

$${θ}_{j + 1}^{k}$$

based on equation (10) and to update the classification head parameter

$${ϕ}_{j + 1}^{k}$$

based on equation (11). In one example embodiment, the core “do” loop is performed for 100 iterations.

A fine-tuning “do” loop is performed to further update the updated backbone model parameter θₜ₊₁ and the classification head parameter ϕₜ₊₁ based on equation (12). In one example embodiment, the fine-tuning “do” loop is performed for 10 iterations. The backbone model parameter θ_{K} and the classification head parameter ϕ_{K} are then output.

### 3. Joint Unsupervised and Supervised Training

### 3.1. Training

To solve the joint training problem (4) efficiently, the penalty-based reformulation of the bilevel problem in (4) is employed; that is

$${min}_{ϕ , θ} {F}_{γ} ( ϕ , θ ) := {L}_{CTC} ( ϕ , θ ) + γ {L}_{NCE} ( ϕ , θ ) \qquad ( 5 )$$

where γ>0 is a penalty constant specified below. The equivalence of the penalized reformulation (5) and the original bilevel problem (4) is rigorously established below.

With the penalized reformulation (5), JUST jointly optimizes the unsupervised and supervised training in a single loop. At first, the backbone parameters θ are randomly initialized with θ₁ and the classification head parameters ϕ are initialized with ϕ₁. Then, applying the gradient descent to the penalized formulation (5) with respect to θ, the backbone model parameters θ are updated; that is, the kth iteration follows:

$${θ}_{k + 1} = {θ}_{k} - α {∇}_{θ} {L}_{CTC} ( {ϕ}_{k} , {θ}_{k} ) - α γ {∇}_{θ} {L}_{NCE} ( {θ}_{k} ) \qquad ( 6 )$$

where α>0 is the learning rate. Please note that, different from the conventional multi-objective training by linearly combining two objective functions, the two gradient terms in (6) are evaluated using labeled and unlabeled data, respectively.

Similarly, using the gradient of the conventional supervised loss (3), the classification head parameters ϕ are updated as follows:

$${ϕ}_{k + 1} = {ϕ}_{k} - β {∇}_{ϕ} {L}_{CTC} ( {ϕ}_{k} , {θ}_{k} ) \qquad ( 7 )$$

where β>0 is a pre-defined learning rate. Hence, the unsupervised training is now coupled with the supervised training step. The JUST algorithm is summarized in Algorithm 1.

During pre-training, the model is trained for a number of iterations, and then fine-tuned in a separate loop. However, the fine-tuning has no impact on the pre-training. In contrast, the JUST method alternates between unsupervised and supervised training, allowing the unsupervised training to receive feedback from the supervised training. This leads to a more cohesive and effective training process.

### 3.2. Convergence

### Assumption 1

Consider the following assumptions:
(a) The loss L_{CTC}(⋅,θ) is L-Lipschitz continuous in ϕ given θ.
(b) Define

$${L}_{NCE}^{*} = {min}_{θ} {L}_{NCE} ( θ ) .$$

There exists μ>0 such that L_{NCE}(θ) satisfies the PL

$$inequality {‖ ∇ {L}_{NCE} ( θ ) ‖}^{2} \geq \frac{1}{μ} ( {L}_{NCE} ( θ ) - {L}_{NCE}^{*} ) .$$

(c) The gradient □F_{γ}(ϕ,θ) is L_{γ}-Lipschitz continuous.

The Lipschitz gradient assumptions are standard in finite-time convergence analysis of gradient based methods. Recent studies found that over-parameterized neural networks can lead to losses that satisfy the PL inequality.

### Lemma 1 (Equivalence of the Penalized Formulation)

Under Assumption 1, with a prescribed accuracy δ>0, set γ≤L\sqrt{3μδ⁻¹}

If (x_{γ}, y_{γ}) is a local/global solution of (5), it is also a local/global solution of the following approximate problem of (4) with some ∈_{γ}≤δ:

$$\begin{matrix}{min}_{ϕ ∈ c , θ ∈ ⊖} {L}_{CTC} ( ϕ , θ ) \\ s . t . {L}_{NCE} ( θ ) - {min}_{θ} {L}_{NCE} ( θ ) \leq {ϵ}_{γ}\end{matrix} \qquad ( 8 )$$

This lemma suggests that the penalized problem in (5) can be solved locally/globally to solve the original problem in (4). To solve (5), the JUST algorithm in Algorithm 1 can be viewed as performing the projected gradient descent method. The theorem on the convergence of Algorithm 1 is presented below.

### Theorem 1 (Convergence Rate of JUST)

### Consider Algorithm

1. Suppose Assumptions 1 hold. Select an accuracy δ and

$$β ∈ ( 0 , {L}_{γ}^{- 1} ] ,$$

γ chosen by Lemma 1. Then it holds that:
i) with C=inf_{(ϕ,θ)} L_{CTC}(ϕ, θ), it holds that

$$\frac{1}{K} {\sum }_{k = 1}^{K} ‖ ∇ {F}_{γ} ( {ϕ}_{k} , {θ}_{k} ) {‖}^{2} \leq \frac{18 ( {F}_{γ} ( {ϕ}_{1 ′} , {θ}_{1} ) - C )}{β K} + \frac{10 {L}^{2} {L}_{γ}^{2}}{K}$$

ii) Suppose

$${lim}_{k \to ∞} ( {ϕ}_{k} , {θ}_{k} ) = ( {ϕ}^{*} , {θ}^{*} ) ,$$

(ϕ*, θ′) is a stationary point of (5). If (ϕ′, θ′) is a local/global solution of the penalized problem (5), then it is a local/global solution of (8) with some ∈_{γ}≤δ.

Theorem 1 suggests the iteration complexity to achieve e-stationary point is [symbol] (L_{γ}∈⁻¹), which matches the complexity of the gradient descent-based supervised training method.

### 4. Experiments

Experiments on ASR tasks were performed to show the effectiveness of JUST and to compare it with supervised baselines and the commonly used PT+FT strategy.

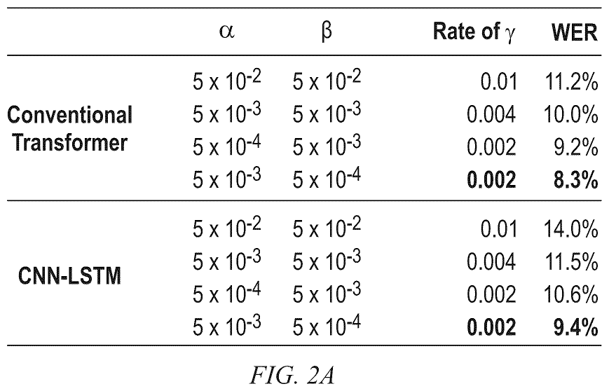

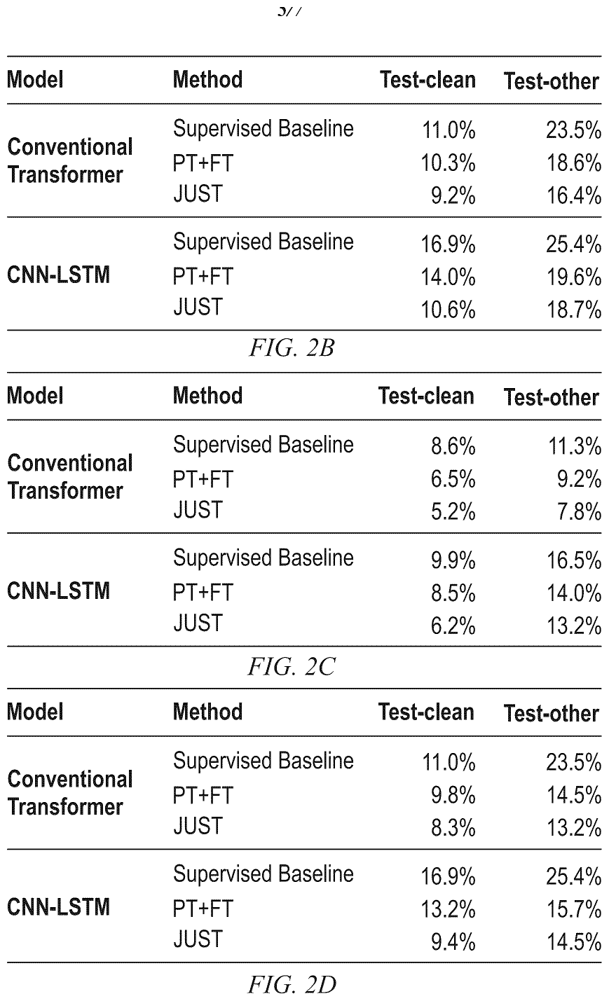

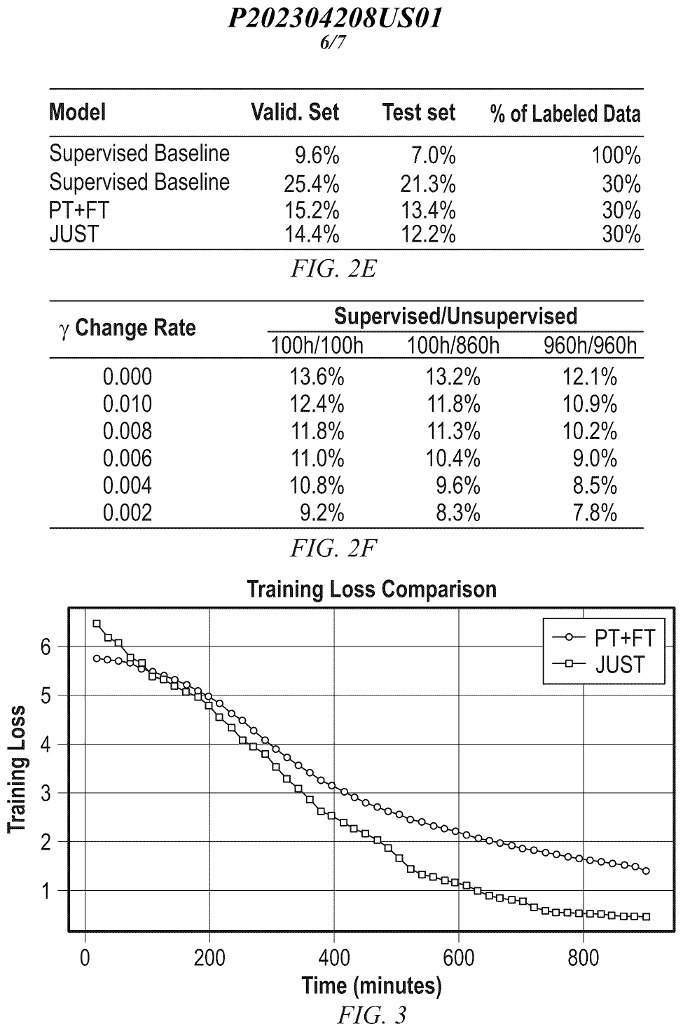

FIG. 2A is a table illustrating the word error rates (WERs) under various hyperparameter settings of JUST using the convolution-augmented transformer and convolutional neural network-long short-term memory (CNN-LSTM) acoustic models on a first conventional dataset, in accordance with an example embodiment. There are 860 hours of data in the lower-level unsupervised training dataset and 100 hours of data in the upper-level supervised training dataset.

FIG. 2B is a table illustrating the WERs for a supervised training baseline, PT+FT and JUST using the convolution-augmented transformer and CNN-LSTM acoustic models, respectively, on the first conventional dataset, in accordance with an example embodiment. There are 100 hours of speech in the training database.

### 4.1. Experimental Setting

Dataset: JUST was evaluated on the first conventional dataset and a second conventional dataset. The first conventional dataset has 960 hours of speech. The second conventional dataset has 207 hours of speech for training and about 4 hours for validation. The sampling rate of both datasets is 16 KHz.

Model: Two model architectures were used for the acoustic models. One is a convolution-augmented transformer, and the other is a bi-directional LSTM model on top of residual convolutional layers, which is referred to as CNN-LSTM. There are 7 convolution-augmented transformer blocks in the convolution-augmented transformer model with 512 hidden units and eight 64-dimensional attention heads in each convolution-augmented transformer block. The convolution kernel size is 31. The convolution-augmented transformer model has about 52 M parameters. The CNN-LSTM model has three convolutional layers on top of which are five LSTM layers. There are 32 feature maps in each convolutional layer with a kernel size 3×3 and stride 1. There are 256×2 hidden units in each LSTM layer. The LSTM acoustic model has about 27 M parameters. For both acoustic models, the input is 80-dimensional logmel features and the output is 1,000 byte pair encoding (BPE) units.

Training strategy: All models were trained using a conventional stochastic optimizer. For supervised models, the learning rate starts with 5×10⁻⁴. In the PT+FT and JUST approaches, learning rates start from 5×10⁻³ for unsupervised training and 5×10⁻⁴ for supervised training. A learning rate scheduler was employed to reduce the learning rate when the validation loss plateaued. Specifically, the patience value was set to 20 and the reduction factor to 0.1. Consequently, the disclosed training process monitored the validation loss for 20 epochs and, if no improvement was observed, it reduced the learning rate by a factor of 0.1. JUST and the baseline methods were trained for 100 epochs. In the case of the PT+FT method, the model was first pre-trained for 100 epochs and subsequently fine-tuned for an additional 100 epochs. In JUST, γ is monotonically increasing from 0 with a linear rate of 0.002 over epochs. These hyperparameters are optimized based on the ASR performance in the table of FIG. 2A. A conventional technique for perturbing and augmenting training data is used for data augmentation in the training.

FIG. 2C is a table illustrating the WERs for a supervised training baseline, PT+FT and JUST using the convolution-augmented transformer and CNN-LSTM acoustic models, respectively, on the first conventional dataset, in accordance with an example embodiment. There are 960 hours of speech in training.

FIG. 2D is a table illustrating the WERs for the supervised training, PT+FT and JUST using the convolution-augmented transformer and CNN-LSTM acoustic models, respectively, on the first conventional dataset, in accordance with an example embodiment. There are 860 hours of speech in the lower-level unsupervised training dataset and 100 hours of speech in the upper-level supervised training dataset. (Upper-level objective: conventional supervised loss; Lower-level objective: CPC loss.)

### 4.2. ASR Performance

JUST was compared with two training approaches. JUST was first compared with supervised training where the acoustic models are trained with labeled data in the conventional manner, which is referred to as the supervised baseline. JUST was also compared with the PT+FT strategy where the acoustic model is first trained with unlabeled data in an unsupervised way and then fine-tuned with labeled data under supervised training.

Three setups on the first conventional dataset with a 100-hour/860-hour split were considered. In Setup 1, only 100 hours of speech was used to train the supervised baseline, PT+FT and JUST. For PT+FT and JUST, the same 100 hours of data were used for both unsupervised and supervised training; see the results in the table of FIG. 2B. In Setup 2, all 960 hours of speech were used to re-run the unsupervised and supervised training like Setup 1; see the results in the table of FIG. 2C. In Setup 3, 100 hours of speech data were used for a supervised baseline. In PT+FT and JUST, 860 hours of speech were used for unsupervised training and 100 hours of speech were used for supervised training; see the results in the table of FIG. 2D. Analogously, experiments were conducted on the second conventional dataset using the convolution-augmented transformer acoustic model. 70% of its data was used for unsupervised training and 30% was used for supervised training. The results are given in the table of FIG. 2E.

From the tables, JUST outperforms the conventional PT+FT and the supervised baseline that only relies on available labeled data. Specifically, in the table of FIG. 2B, JUST outperforms PT+FT by almost 1% using the convolution-augmented transformer and 3.5% using CNN-LSTM. With more data for unsupervised and supervised training, this margin increases. In the tables of FIGS. 2C and 2D, JUST outperforms PT+FT by almost 1.3% and 1.5% using the convolution-augmented transformer and 2.3% and 3.8% using CNN-LSTM, respectively. Similar observations can also be made in the table of FIG. 2E on the second conventional dataset.

It is noted that JUST combines unsupervised and supervised training in a single training loop which effectively reduces the number of epochs needed. FIG. 3 shows a comparison between the computational cost of PT+FT and JUST. To generate FIG. 3, the time taken by the PT+FT method for pre-training and separately for fine-tuning was first recorded. These times were then combined to calculate the total time. For the JUST method, a single training time need only be measured since JUST combines both supervised and unsupervised training within a single loop. The loss value here is the conventional supervised loss. It shows that JUST takes much less time to achieve a certain loss value compared to PT+FT.

FIG. 2E is a table illustrating the WERs on the second conventional dataset using the convolution-augmented transformer acoustic model, in accordance with example embodiments. (Upper-level objective: conventional supervised loss; Lower-level objective: CPC loss.)

FIG. 2F is a table illustrating the effect of the rate of change of penalty constant in bilevel optimization under various amounts of supervised and unsupervised data, in accordance with example embodiments.

FIG. 3 illustrates training losses of JUST vs. PT+FT on 100 hours of speech using the first conventional dataset, in accordance with example embodiments. The acoustic model is the convolution-augmented transformer.

### 4.3. Effect of Penalty Constant

The impact of the penalty constant, γ, of bilevel optimization to JUST was investigated. The table of FIG. 2F shows the WERs under different growth rates of γ, in accordance with example embodiments. The growth rate was gradually increased starting from 0. A slowly increasing γ gives better performance over the constant γ. The best rate is 0.002 which is consistent across all setups on the first conventional dataset.

Given the discussion thus far, it will be appreciated that, in general terms, an exemplary method, according to an aspect of the invention, includes the operations of randomly initializing a backbone model parameter and a classification head parameter; applying a gradient descent to a lower-level unsupervised loss with respect to the initialized backbone model parameter and updating the initialized backbone model parameter; applying a gradient descent to a higher-level supervised loss and updating the initialized classification head parameter; and facilitating deployment of the updated backbone model parameter and the updated classification head parameter.

The technical benefits include a reduction in the training time and computational resources for pre-training and fine-tuning a neural network model, especially for large datasets; a better feature representation for machine learning with improved ASR performance; and a single training loop for combined unsupervised and supervised training which effectively reduces the number of epochs needed for training.

In one aspect, a computer program product comprises one or more tangible computer-readable storage media and program instructions stored on at least one of the one or more tangible computer-readable storage media, the program instructions executable by a processor, the program instructions comprising randomly initializing a backbone model parameter and a classification head parameter; applying a gradient descent to a lower-level unsupervised loss with respect to the initialized backbone model parameter and updating the initialized backbone model parameter; applying a gradient descent to a higher-level supervised loss and updating the initialized classification head parameter; and facilitating deployment of the updated backbone model parameter and the updated classification head parameter.

In one aspect, an apparatus comprises a memory and at least one processor, coupled to the memory, and operative to perform operations comprising randomly initializing a backbone model parameter and a classification head parameter; applying a gradient descent to a lower-level unsupervised loss with respect to the initialized backbone model parameter and updating the initialized backbone model parameter; applying a gradient descent to a higher-level supervised loss and updating the initialized classification head parameter; and facilitating deployment of the updated backbone model parameter and the updated classification head parameter.

In one example embodiment, the applying of the gradient descent to the lower-level unsupervised loss further comprises updating the initialized backbone model parameter based on:

$${θ}_{k + 1} = {θ}_{k} - α {∇}_{θ} {L}_{sup e r v i s e d} ( {ϕ}_{k} , {θ}_{k} ) - α γ {∇}_{θ} {L}_{u n sup e r v i s e d} ( {θ}_{k} ) \qquad ( 6 )$$

where α>0 is an unsupervised learning rate, θ represents the backbone model parameter, L_{supervised} is a supervised loss function and L_{unsupervised} is an unsupervised loss function; and wherein the applying the gradient descent to the higher-level supervised loss further comprises updating the initialized classification head parameter based on:

$${ϕ}_{k + 1} = {ϕ}_{k} - β {∇}_{ϕ} {L}_{sup e r v i s e d} ( {ϕ}_{k} , {θ}_{k} ) \qquad ( 7 )$$

where β>0 is a supervised learning rate and ϕ represents the classification head parameter.

In one example embodiment, pre-training of the backbone model parameter and the classification head parameter are performed using a second unsupervised loss function.

In one example embodiment, the pre-training is performed using an unsupervised learning rate of the applying the gradient descent to the lower-level unsupervised loss operation.

In one example embodiment, fine-tuning of the updated backbone model parameter and the updated classification head parameter are performed.

In one example embodiment, the performing fine-tuning uses the supervised loss function and a smaller learning rate than a supervised learning rate of the applying the gradient descent to the higher-level supervised loss.

In one example embodiment, the lower-level unsupervised loss is a noise-contrastive estimation loss and the higher-level supervised loss is a connectionist temporal classification loss.

In one example embodiment, an unsupervised training stage that learns generic representations of speech signals that can be fine-tuned for a particular task as the lower-level problem corresponding to the lower-level unsupervised loss is considered, wherein a result of the lower-level problem is a set of lower-level model parameters of backbone layers that promote learning in an upper-level supervised training stage that minimizes a task-specific loss given the lower-level model parameters.

In one example embodiment, the higher-level supervised loss maximizes a probability of predicting a future sample xₜ₊ₚ given a contextual representation Cₜ(θ) generated from a speech sequence {x₁, x₂, . . . , xₜ} up to time t using a neural network parameterized by the updated backbone model parameter.

In one example embodiment, the higher-level supervised loss minimizes a negative log-likelihood of a label sequence yₙ, given by:

$${L}_{supervised} ( ϕ , θ ) = \frac{1}{N} {\sum }_{n = 1}^{N} - log P ( {y}_{n} \vert z ( {x}_{n} ; ϕ , θ ) )$$

where z(xₙ; ϕ,θ) is an output of a corresponding model, ϕ represents parameters of a classification layer of the corresponding model, and θ includes all parameters except those from the classification layer.

In one example embodiment, the lower-level unsupervised loss is defined as:

$${min}_{ϕ , θ} {L}_{sup e r v i s e d} ( ϕ , θ )$$

$$S . t . θ ∈ S : = arg {min}_{θ} {L}_{u n sup e r v i s e d} ( θ )$$

In one example embodiment, the lower-level unsupervised loss of a bilevel problem corresponding to bi-level training is employed and defined by:

$${min}_{ϕ , θ} {F}_{γ} ( ϕ , θ : = {L}_{sup e r v i s e d} ( ϕ , θ ) + γ {L}_{u n sup e r v i s e d} ( ϕ , θ )$$

where γ>0 is a penalty constant.

In one example embodiment, inferencing is performed using the output backbone model parameter and the output classification head parameter.

In one example embodiment, training data for the method is speech recognition data and the inferencing is performed on input speech, and speech recognition is performed on the input speech based on results of the inferencing.

In one example embodiment, the input speech is at least one of raw audio and log-Mel features of an audio track.

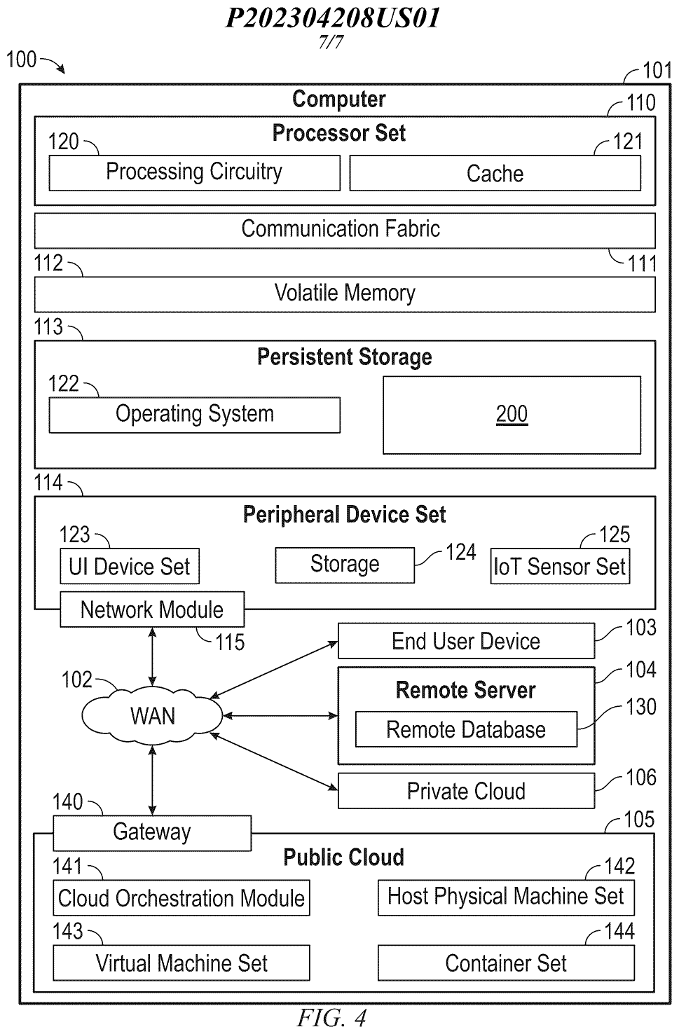

Reference should now be had to FIG. 4.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 4. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
randomly initializing a backbone model parameter and a classification head parameter;
applying a gradient descent to a lower-level unsupervised loss with respect to the initialized backbone model parameter and updating the initialized backbone model parameter;
applying a gradient descent to a higher-level supervised loss and updating the initialized classification head parameter; and
facilitating deployment of the updated backbone model parameter and the updated classification head parameter.

2. The computer-implemented method of claim 1, wherein the applying the gradient descent to the lower-level unsupervised loss further comprises updating the initialized backbone model parameter based on:
$${θ}_{k + 1} = {θ}_{k} - α {∇}_{θ} {L}_{sup e r v i s e d} ( {ϕ}_{k} , {θ}_{k} ) - α γ {∇}_{θ} {L}_{u n sup e r v i s e d} ( {θ}_{k} )$$
where α>0 is an unsupervised learning rate, θ represents the backbone model parameter, L_{supervised} is a supervised loss function and L_{unsupervised} is an unsupervised loss function; and
wherein the applying the gradient descent to the higher-level supervised loss further comprises updating the initialized classification head parameter based on:
$${ϕ}_{k + 1} = {ϕ}_{k} - β {∇}_{ϕ} {L}_{supervised} ( {ϕ}_{k} , {θ}_{k} )$$
where β>0 is a supervised learning rate and ϕ represents the classification head parameter.

3. The computer-implemented method of claim 1, further comprising performing pre-training of the backbone model parameter and the classification head parameter using a second unsupervised loss function.

4. The computer-implemented method of claim 3, wherein the pre-training is performed using an unsupervised learning rate of the applying the gradient descent to the lower-level unsupervised loss operation.

5. The computer-implemented method of claim 1, further comprising performing fine-tuning of the updated backbone model parameter and the updated classification head parameter.

6. The computer-implemented method of claim 5, wherein the performing fine-tuning uses the supervised loss function and a smaller learning rate than a supervised learning rate of the applying the gradient descent to the higher-level supervised loss.

7. The computer-implemented method of claim 1, wherein the lower-level unsupervised loss is a noise-contrastive estimation loss and the higher-level supervised loss is a connectionist temporal classification loss.

8. The computer-implemented method of claim 1, further comprising considering an unsupervised training stage that learns generic representations of speech signals that can be fine-tuned for a particular task as the lower-level problem corresponding to the lower-level unsupervised loss, wherein a result of the lower-level problem is a set of lower-level model parameters of backbone layers that promote learning in an upper-level supervised training stage that minimizes a task-specific loss given the lower-level model parameters.

9. The computer-implemented method of claim 1, wherein the higher-level supervised loss maximizes a probability of predicting a future sample xₜ₊ₚ given a contextual representation Cₜ(θ) generated from a speech sequence {x₁, x₂, . . . , xₜ} up to time t using a neural network parameterized by the updated backbone model parameter.

10. The computer-implemented method of claim 1, wherein the higher-level supervised loss minimizes a negative log-likelihood of a label sequence yₙ, given by:
$${L}_{supervised} ( ϕ , θ ) = \frac{1}{N} {\sum }_{n = 1}^{N} - log P ( {y}_{n} \vert z ( {x}_{n} ; ϕ , θ ) )$$
where z(xₙ; ϕ,θ) is an output of a corresponding model, ϕ represents parameters of a classification layer of the corresponding model, and θ includes all parameters except those from the classification layer.

11. The computer-implemented method of claim 1, wherein the lower-level unsupervised loss is defined as:
$${min}_{ϕ , θ} {L}_{sup e r v i s e d} ( ϕ , θ )$$
$$S . t . θ ∈ S : = arg {min}_{θ} {L}_{u n sup e r v i s e d} ( θ )$$

12. The computer-implemented method of claim 1, wherein the lower-level unsupervised loss of a bilevel problem corresponding to bi-level training is employed and defined by:
$${min}_{ϕ , θ} {F}_{γ} ( ϕ , θ ) : = {L}_{sup e r v i s e d} ( ϕ , θ ) + γ {L}_{u n sup e r v i s e d} ( ϕ , θ )$$
where γ>0 is a penalty constant.

13. The computer-implemented method of claim 1, further comprising performing inferencing using the output backbone model parameter and the output classification head parameter.

14. The computer-implemented method of claim 13, wherein training data for the method is speech recognition data and wherein the inferencing is performed on input speech, further comprising performing speech recognition on the input speech based on results of the inferencing.

15. The computer-implemented method of claim 14, wherein the input speech is at least one of raw audio and log-Mel features of an audio track.

16. A computer program product, comprising:
one or more tangible computer-readable storage media and program instructions stored on at least one of the one or more tangible computer-readable storage media, the program instructions executable by a processor, the program instructions comprising:
randomly initializing a backbone model parameter and a classification head parameter;
applying a gradient descent to a lower-level unsupervised loss with respect to the initialized backbone model parameter and updating the initialized backbone model parameter;
applying a gradient descent to a higher-level supervised loss and updating the initialized classification head parameter; and
facilitating deployment of the updated backbone model parameter and the updated classification head parameter.

17. A system comprising:
a memory; and
at least one processor, coupled to said memory, and operative to perform operations comprising:
randomly initializing a backbone model parameter and a classification head parameter;
applying a gradient descent to a lower-level unsupervised loss with respect to the initialized backbone model parameter and updating the initialized backbone model parameter;
applying a gradient descent to a higher-level supervised loss and updating the initialized classification head parameter; and
facilitating deployment of the updated backbone model parameter and the updated classification head parameter.

18. The system of claim 17, wherein the applying the gradient descent to the lower-level unsupervised loss further comprises updating the initialized backbone model parameter based on
$${θ}_{k + 1} = {θ}_{k} - α {∇}_{θ} {L}_{sup e r v i s e d} ( {ϕ}_{k} , {θ}_{k} ) - α γ {∇}_{θ} {L}_{u n sup e r v i s e d} ( {θ}_{k} )$$
where α>0 is an unsupervised learning rate, θ represents the backbone model parameter, L_{supervised} is a supervised loss function and L_{unsupervised} is an unsupervised loss function; and
wherein the applying the gradient descent to the higher-level supervised loss further comprises updating the initialized classification head parameter based on
$${ϕ}_{k + 1} = {ϕ}_{k} - β {∇}_{ϕ} {L}_{sup e r v i s e d} ( {ϕ}_{k} , {θ}_{k} )$$
where β>0 is a supervised learning rate and ϕ represents the classification head parameter.

19. The system of claim 17, the operations further comprising performing pre-training of the backbone model parameter and the classification head parameter using a second unsupervised loss function.

20. The system of claim 17, the operations further comprising performing fine-tuning of the updated backbone model parameter and the updated classification head parameter.
